(19) United States
(12) Patent Application Publication
(10) Pub. No.: US 2023/0261690 A1
(43) Pub. Date: Aug. 17, 2023

(54) Dual Chirp Modulation Scheme

(71) Applicant: THE REGENTS OF THE UNIVERSITY OF MICHIGAN, Ann Arbor, MI (US)

(72) Inventors: David WENTZLOFF, Ann Arbor, MI (US); Milad MOOSAVIFAR, Ann Arbor, MI (US); Jaeho IM, Ann Arbor, MI (US)

(21) Appl. No.: 17/672,877

(22) Filed: Feb. 16, 2022

(51) Int. Cl. H04B 1/692; H04B 1/04

(52) U.S. Cl. CPC H04B 1/692; H04B 1/04; H04B 2001/6912

(57) ABSTRACT

A dual chirp modulation technique is presented for use in telecommunications. The technique includes: generating a first chirp signal ramping at a first rate; generating a second chirp signal ramping at a second rate which differs from the first rate; combining the first chirp signal with the second chirp signal to form a dual chirped signal; and transmitting, the dual chirped signal from a transmitter to a receiver. At least one first chirp signal, the second chirp signal or the dual chirped signal is preferably modulated. At the receiver, the dual chirped signal is correlated with a local chirp signal to help reject out-of-band interferers.

### GOVERNMENT CLAUSE

This invention was made with government support under DE-EE0008225 awarded by the U.S. Department of Energy. The government has certain rights in the invention.

### FIELD

The present disclosure relates to a dual chirp modulation scheme.

### BACKGROUND

As the number of devices connected to the IoT has increased rapidly in recent years, stricter requirements have been placed on radio receivers (RX) that can operate in an increasingly crowded spectrum while maintaining ultra-low-power (ULP) consumption, high sensitivities, and low cost. Prior ULP radios utilizing on-off keying (OOK) modulation with <1 μW power consumption offer good sensitivity, but are susceptible to in-band (IB) and out-of-band (OOB) interference and have high latency overhead. High-Q off-chip MEMS resonators and envelope tracking loops can mitigate OOB blockers and continuous wave IB blockers, but fail to reject IB pulsed blockers common in the populated ISM bands. Two-tone OOK modulation can alleviate OOB blockers, but struggles to address close IB blockers and transient pulsed interferences. Some previous works achieve strong blocker rejection, but come at the cost of lower sensitivity and higher power consumption compared to other ULP RXs. To address these challenges, this disclosure proposes a new dual chirp modulation scheme which achieves strong IB and OOB blocker rejection without sacrificing other important RX metrics of sensitivity, power, data rate, and cost.

This section provides background information related to the present disclosure which is not necessarily prior art.

### SUMMARY

This section provides a general summary of the disclosure, and is not a comprehensive disclosure of its full scope or all of its features.

A dual chirp modulation scheme is presented for transmitting signals. The method includes: generating a first chirp signal ramping at a first rate; generating a second chirp signal ramping at a second rate which differs from the first rate; combining the first chirp signal with the second chirp signal to form a combined chirp signal; modulating at least one first chirp signal, the second chirp signal and the combined chirp signal; and transmitting the modulated signal from the transmitter to a receiver. On the receiver side, the signal received from the transmitter is correlated with a local chirp signal, where the local chirp signal is a chirp signal ramping at a rate that matches the ramp rate of the transmitted modulated signal.

In one aspect, a communication system is presented. The transmitter includes: a first signal generator outputting a first chirp signal ramping at a first rate; a second signal generator outputting a second chirp signal ramping at a second rate which differs from the first rate; a signal combiner configured to receive the first chirp signal and the second chirp signal and operates to combine the first chirp signal with the second chirp signal to form a combined chirp signal; and a modulator configured to receive the combined chirp signal and modulate the combined chirp signal using on-off keying. The receiver includes a mixer configured to receive a signal from the transmitter and correlate the received signal with a local chirp signal, where the local chirp signal is a chirp signal ramping at a rate that matches the ramp rate of the transmitted modulated signal. The receiver may further include a downconverter configured to receive the transmitted modulated signal and down convert the transmitted modulated signal to a lower frequency to form an intermediate frequency signal; and a bandpass filter configured to receive the intermediate frequency signal from the downconverter.

In another aspect, the transmitter includes: a first signal generator outputting a first chirp signal ramping at a first rate; a second signal generator outputting a second chirp signal ramping at a second rate which differs from the first rate; a third signal generator outputting a third chirp signal ramping at a third rate which differs from the first rate and the second rate; a chirp selector configured to receive the second chirp signal and the third chirp signal and operates to select one of the second chirp signal and the third chirp signal to output at a given time in accordance with an input signal; and a signal combiner configured to receive the first chirp signal and output from the chirp selector and operates to combine the first chirp signal with the output from the chirp selector to form a combined chirp signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a first example embodiment of a transmitter implementing a dual chirp modulation scheme.

FIG. 2 is a diagram of an example embodiment of a receiver intended for use with the transmitter shown in FIG. 1.

FIGS. 3A-3E are diagrams showing the waveforms for the dual chirp modulation scheme using on-off keying.

FIG. 4A is a diagram illustrating how to synchronize the incoming packet with the local chirp signal.

FIG. 4B is a diagram showing a proposed packet structure for the dual chirp modulation scheme.

FIG. 5 illustrates an example finite state machine for use in the receiver.

FIG. 6 is a block diagram for an example implementation of the digital signal processor in the receiver.

FIGS. 7A and 7B are schematics of example embodiments for a receiver frontend circuit and a chirp PLL circuit, respectively.

FIG. 8 is a diagram of an alternative example embodiment of a transmitter implementing a dual chirp modulation scheme.

FIG. 9 is a diagram of another example embodiment of a transmitter implementing a dual chirp modulation scheme.

Corresponding reference numerals indicate corresponding parts throughout the several views of the drawings.

### DETAILED DESCRIPTION

Example embodiments will now be described more fully with reference to the accompanying drawings.

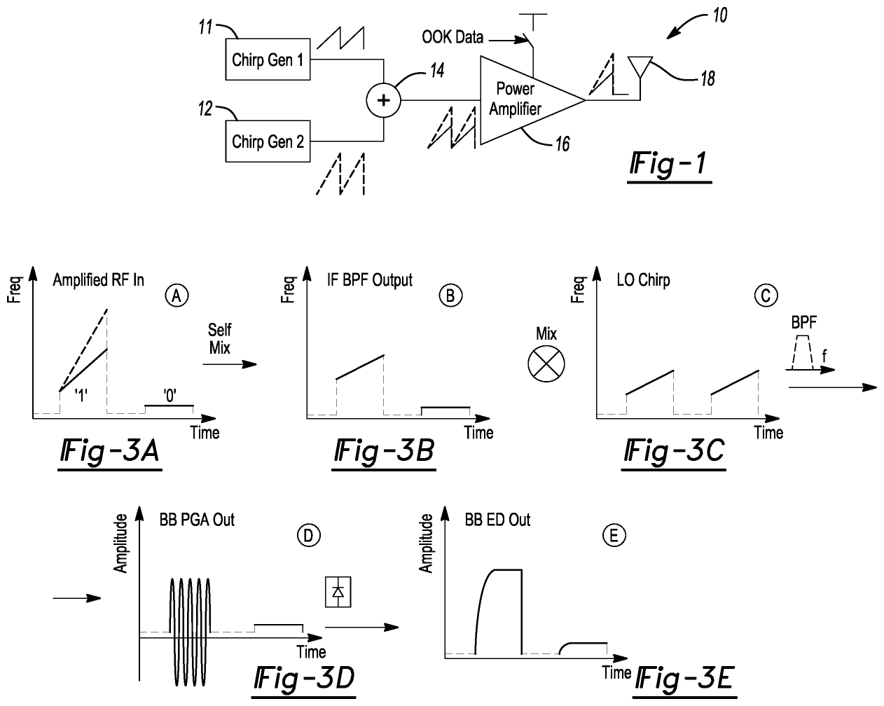

FIG. 1 depicts an example embodiment of a transmitter 10 for use in a wireless communication system. The transmitter 10 includes a first signal generator 11, a second signal generator 12, a signal combiner 14 and a modulator 16. The transmitter further includes an antenna 18 electrically coupled to the modulator for wirelessly transmitting a signal. While reference is made to a wireless communication system, it is readily understood that the broader aspects of the dual chirp modulation scheme are applicable to wired communications as well.

In operation, the first signal generator 11 outputs a first chirp signal ramping at a first rate; the second signal generator 12 outputs a second chirp signal ramping at a second rate which differs from the first rate. It is noted that both chirp signals repeat at the same symbol rate. The signal combiner 14 is configured to receive the first chirp signal and the second chirp signal and operates to combine the first chirp signal with the second chirp signal to form a dual chirp signal. In an example embodiment, the signal combiner 14 is an adder circuit.

The modulator 16 is configured to receive the dual chirp signal and modulate the dual chirp signal, for example using on-off keying. In the example embodiment, the modulator is a power amplifier, such that dual chirp signal is modulated by enabling and disabling the power amplifier. The modulated signal is in turn output to the antenna 18 associated with the transmitter. As a result, the dual chirp signal is transmitted for the “on” symbol but nothing is transmitted for the “off” symbol. It is to be understood that only the relevant components of the transmitter are discussed in relation to FIG. 1, but that other components may be needed to control and manage the overall operation of the transmitter.

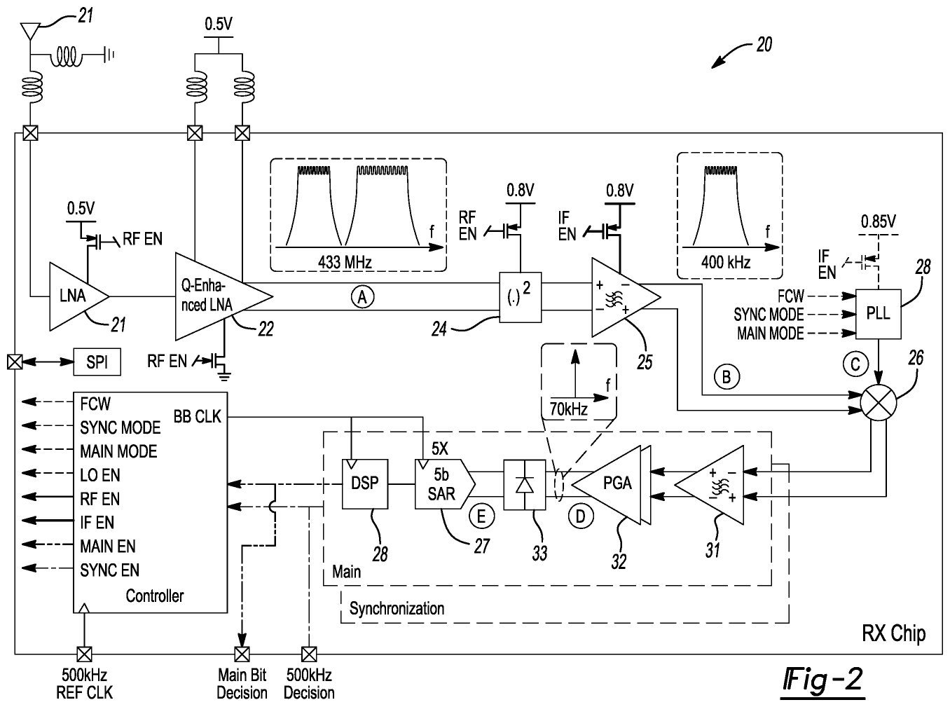

FIG. 2 depicts an example embodiment of a receiver 20 for use in a wireless communication system. The receiver 20 includes a downconverter 24, a bandpass filter 25, a mixer 26, an analog-to-digital converter 27 and a digital signal processor 28.

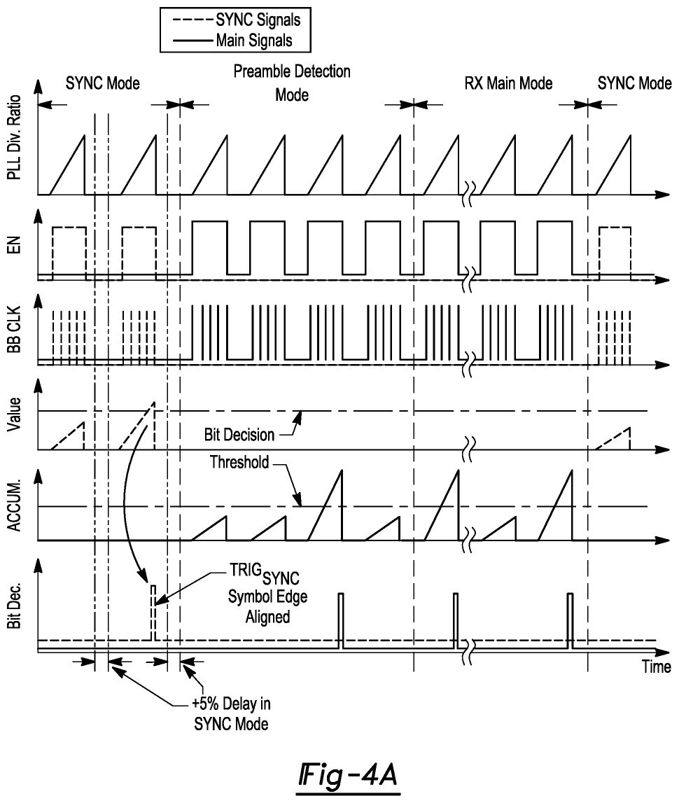

In operation, the downconverter 24 is configured to receive an incoming signal via an antenna 21 from the transmitter 10. Prior to the downconversion, the incoming signal may be amplified by a RF front end circuit to maximize the self-mixer conversion gain while rejecting out-of-band interferers. In the example embodiment, the incoming signal is amplified by two low noise amplifiers 21, 22. The downconverter 24 in turn down converts the incoming signal (FIG. 3A) to a lower frequency to form an intermediate frequency (IF) signal. The intermediate frequency signal includes a single low frequency chirp due to the intermodulation of the dual chirps passing through a squaring operation. The intermediate frequency signal is therefore the difference between two chirp signal frequencies.

Next, the intermediate frequency signal is passed through a bandpass filter 25. The filtered IF signal is seen as a chirp signal (symbol 1) or zero energy signal (symbol 0) as seen in FIG. 3B. The mixer 26 is configured to receive the filtered IF signal and correlate the filtered IF signal with a local chirp signal. With reference to FIG. 3C, the local chirp signal is a chirp signal ramping at a rate that matches the ramp rate of the transmitted modulated signal from the transmitter 10. In this way, the mixer 26 rejects incoming blocker signals in the desired channel by spreading them in frequency. The output from the mixer 26 may pass through a second bandpass filter 31 and a programmable gain amplifier 32.

Amplitude information is extracted from the correlated signal, for example using an envelope detector 33 as seen in FIGS. 3D and 3E. FIG. 3D shows the signal entering the envelope detector 33 and FIG. 3E shows the signal exiting the envelope detector 33. Lastly, the signal from the envelope detector 33 is digitized by the analog-to-digital converter 27 and input to digital signal processor 28. In the example embodiment, the signal is digitized with 5 times oversampling ratio followed by a majority voting digital demodulator which improves SNR requirements for the given bit error rate by 4 dB.

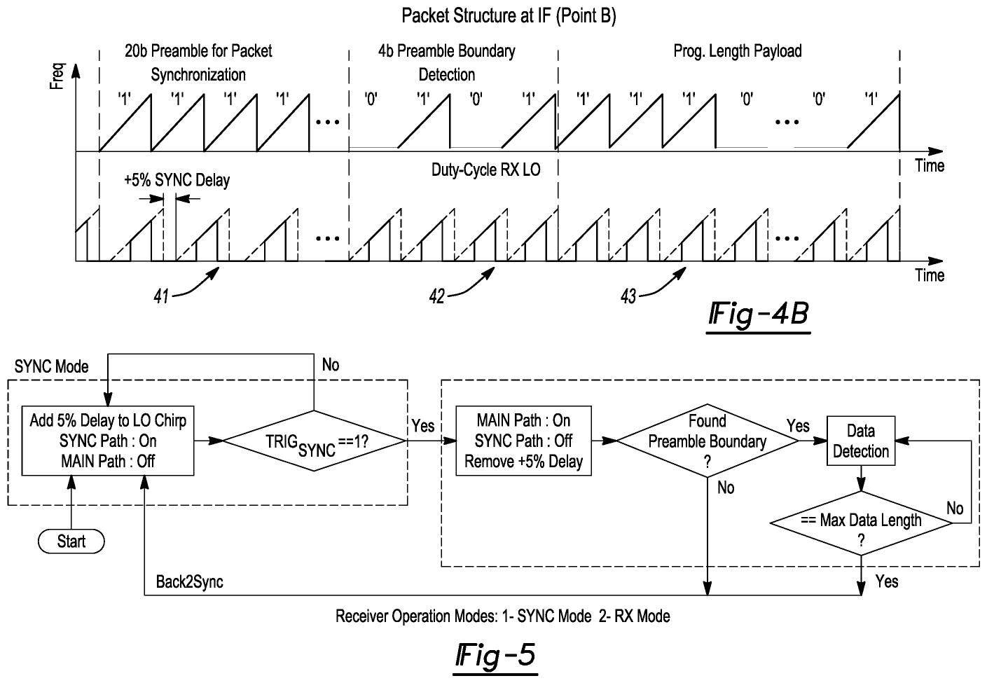

In order to operate the receiver 20, the RF packet and the local chirp signal must be synchronized as shown in FIG. 4A. To ensure robustness of packet synchronization, two different efforts were made on each side of the communication system. On the transmitter side, the RF packet is structured to assist the receiver in synchronizing with the local oscillator and demodulating the dual-chirp modulated packet data. FIG. 4B illustrates the DC-OOK modulated packet. The received packet is composed of three different frames: 1) 20b packet synchronization frame 41 for timing alignment between the RF packet and the receiver; 2) 4b preamble detection frame 42 for detecting the start of the main data in the packet; and 3) a programmable length payload 43.

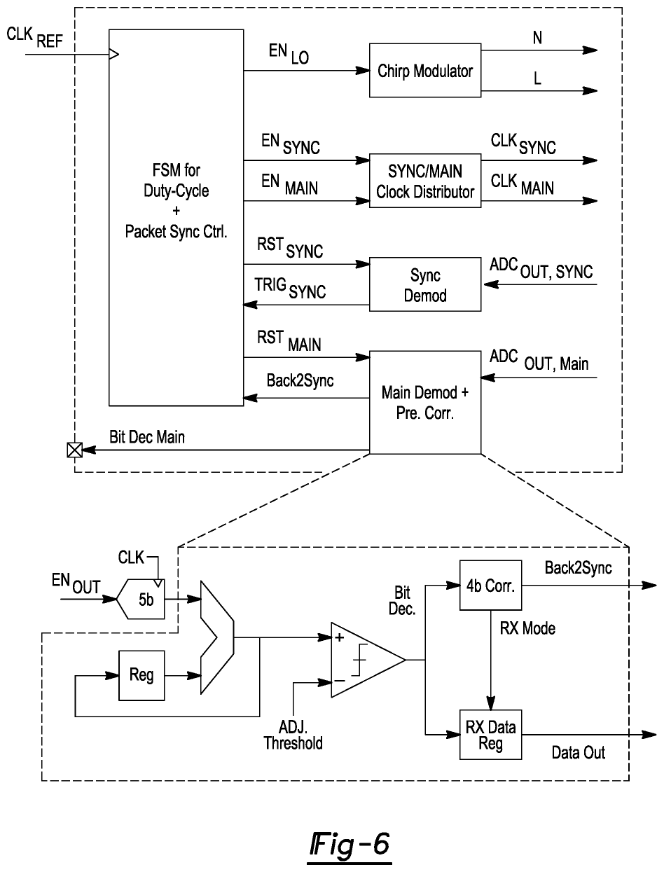

On the receiver side, the receiver synchronizes and receives the payload data from the RF packet with the help of an on-chip finite state machine (FSM) that manages the RF packet-level operation and bit-level duty-cycling. FIG. 5 illustrates an example finite state machine for use in the receiver 20. Packet level operation at the receiver is composed of two different modes: the packet synchronization (SYNC) mode and the main receive (RX) mode, respectively. By default, the duty-cycled receiver is operating in a SYNC mode that searches for the RF synchronization frame by enabling the SYNC BB path, disabling the Main BB path, and generating a sliding LO chirp. As soon as the SYNC demodulator detects ‘1’ from the 20b packet SYNC frame, the SYNC demodulator handshakes with the finite state machine to shift the operation mode from the SYNC mode to the Main RX mode, where the Main BB path is enabled and SYNC BB path is turned off.

In the main mode, the receiver 20 determines the start of the data packet by detecting the preamble. After successful preamble detection, the FSM moves to data reception mode to receive a programmable-length data payload. The FSM forces the receiver 20 to go back to the default operation (SYNC) mode as soon as the number of data reception cycles reaches its maximum data length. The reference clock's specification defines the total data length of the packet for robust DC-OOK communication. In the example embodiment, the receiver 20 is able to capture a data length of 80 ms with an analog baseband bandwidth of 8 kHz when the chirp bandwidth is 40 kHz at a relaxed periodic jitter of <0.5 ns (˜250 ppm) from the 500 kHz reference clock.

FIG. 6 is a block diagram for an example implementation of the digital signal processor. In every oversampled ADC period, the demodulator accumulates the ADC output within a symbol duration and makes a decision on the final ADC sample period by comparing it with an adjustable threshold. The bit-level duty-cycling is managed by the main FSM. Duty cycling is composed of three different states: 1) the idle mode disables all the blocks of the receiver; 2) the precharge mode is placed prior to the active state that settles the operation of PLL and slow bias circuits; and 3) the active mode enables all blocks for signal reception for each RF packet with an adjustable time delay. With 2.5 kbps data-rate, the bit-level duty cycling operation has 200 μs of precharge mode and 200 μs of active mode. The average power of the receiver can be reduced further by scaling the symbol rate from the FSM and aggressively bit-level duty-cycling the symbol.

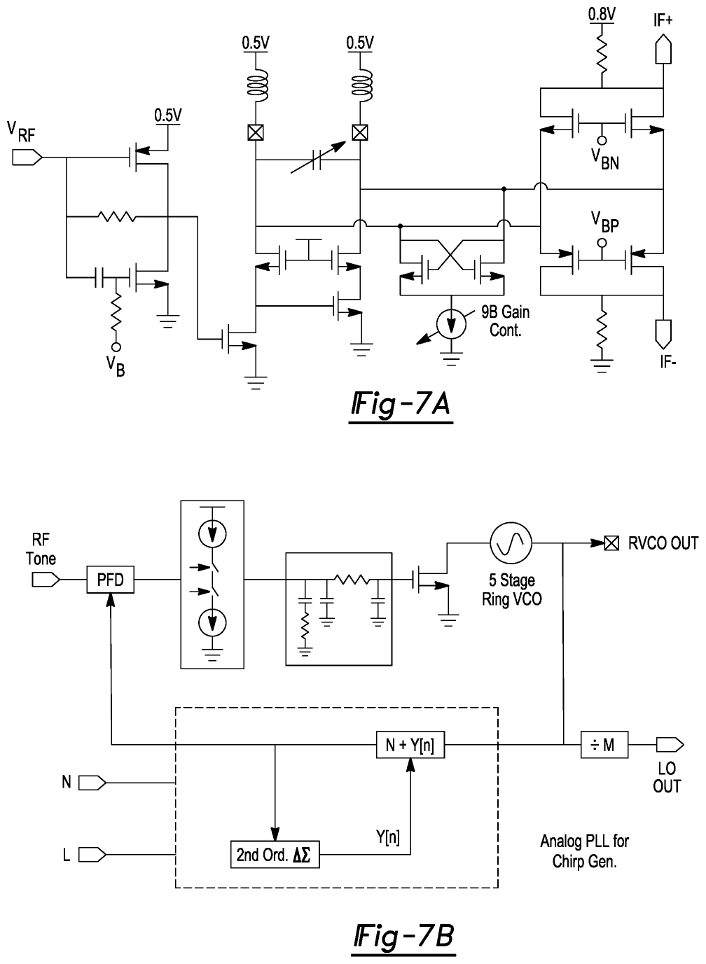

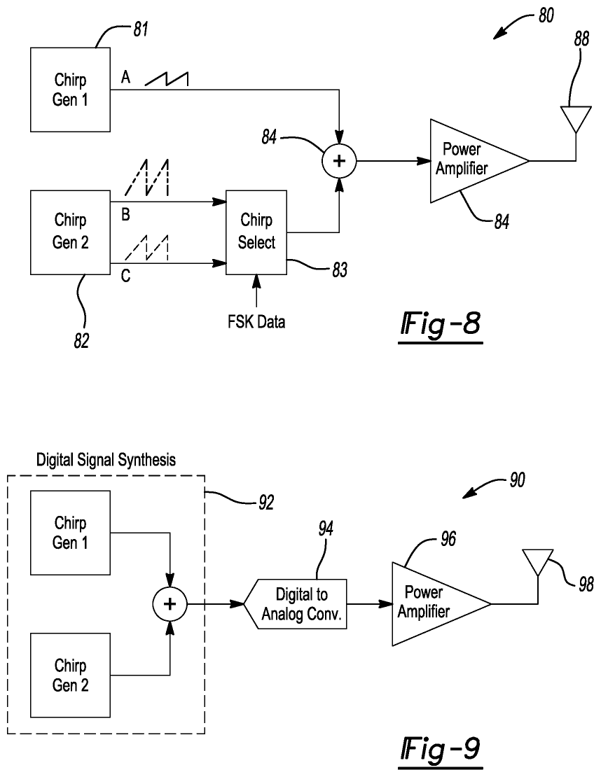

FIGS. 7A and 7B are schematics for example embodiments of the frontend circuits and the chirp PLL circuits, respectively. In the frontend circuit, the RF amplifier chain consists of a current-reused LNA and a Q-enhanced single-ended to differential amplifier with off-chip load inductors, operating at 0.5V. The Q-enhanced amplifier was chosen to provide >45 dB RF gain at low power consumption and to provide steep gain roll-off for filtering OOB blockers. The bandwidth of the RF frontend stages was co-optimized with the dual-chirp bandwidth at RF in order to maximize IB blocker rejection while maintaining sensitivity. A current-reuse self-mixer down-converts the RF signal to a 400 kHz IF frequency. The resulting IF signal is filtered and amplified by a 2nd order BPF and the desired sideband is correlated with the 50% duty-cycled chirp LO via a passive mixer that translates the IF chirp to a 70 kHz tone. The baseband rectifier is a passive 14-stage differential ED that feeds a sub-μW 5b synchronous SAR ADC with 5×OSR.

A charge pump based analog PLL is implemented to generate the local chirp signal as shown in FIG. 7B. The PLL generates a duty-cycled local chirp signal by modulating 4b N and 10b L registers that define the fractional frequency division ratio by the 2nd order ΔΣ modulator. In order to get a smooth local chirp, the PLL generates LO for the IF mixer by dividing the PLL output frequency by 5b M register. A current-starved 5-stage ring-VCO is used to provide low power operation. To minimize the dithering effect on the PLL that impacts the blocker performance of the receiver, a 500 kHz reference clock frequency with N=8 was chosen. The PLL is operated from 4.34 MHz-4.9 MHz to provide 310-350 kHz LO chirp for 200 μs (100 reference cycles).

The dual chirp modulation scheme presented above is not limited to on-off keying. FIG. 8 depicts an alternative embodiment of a transmitter 80 that implements the dual chirp modulation scheme. In a similar manner, the transmitter 80 includes a first signal generator 81, a second signal generator 82, a signal combiner 84, an amplifier 86 and an antenna 88. The transmitter 80 further includes chirp selector 83 electrically coupled between the second signal generator 82 and the signal combiner 84.

In operation, the first signal generator 81 outputs a first chirp signal ramping at a first rate. The second signal generator 82 selectively outputs a second chirp signal ramping at a second rate which differs from the first rate and a third chirp signal ramping at a third rate which differs from the first rate and the second rate. In some embodiments, the second signal generator 82 may be replaced by two separate signal generators. The chirp selector 83 is configured to receive the second chirp signal and the third chirp signal and operates to select one of the second chirp signal and the third chirp signal to output at a given time in accordance with an input signal. For example, the chirp selector 83 may select the second chirp signal or the third chirp selector based on FSK data. The signal combiner 84 is configured to receive the first chirp signal and output from the chirp selector 83 and operates to combine the first chirp signal with the output from the chirp selector to form a dual chirp signal. In this way, the dual chirp signal is modulated using frequency-shift keying.

The dual chirp signal is fed into the power amplifier 86 before being input into the antenna 88. It is to be understood that only the relevant components of the transmitter are discussed in relation to FIG. 8, but that other components may be needed to control and manage the overall operation of the transmitter.

FIG. 9 depicts another embodiment of a transmitter 90 that implements the dual chirp modulation scheme. In this embodiment, signal generation and modulation is done entirely in the digital domain, for example with a digital signal processor 92. Two discrete chirp signals are produced at the desired chirp rates and amplitude and then combined. The combined signal may be modulated using either on-off keying or frequency-shift keying. In one embodiment, both modulation techniques can be combined into a higher-order modulation scheme. Signals from the digital domain are converted to signals in the analog domain using a digital-to-analog converter (DAC) 94. Depending on the performance of the DAC, the analog signals could be directly generated in the RF frequency range or the DAC could operate at a lower frequency. Analog signal at a lower frequency are then upconverted to the desired frequency, for example using a up-conversion mixer and RF local oscillator. Lastly, the analog signal is amplified by an amplifier 96 before being transmitted.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for transmitting signals, comprising:
generating, by a transmitter, a first chirp signal ramping at a first rate;
generating, by the transmitter, a second chirp signal ramping at a second rate which differs from the first rate;
combining the first chirp signal with the second chirp signal to form a combined chirp signal;
modulating at least one first chirp signal, the second chirp signal and the combined chirp signal; and
transmitting the modulated signal from the transmitter to a receiver.

2. The method of claim 1 further comprises combining the first chirp signal with the second chirp signal using an adder circuit.

3. The method of claim 1 further comprises combining the first chirp signal with the second chirp signal in digital domain using a digital signal processor.

4. The method of claim 1 further comprises modulating at least one first chirp signal, the second chirp signal and the combined chirp signal using on-off keying.

5. The method of claim 1 further comprises modulating at least one first chirp signal, the second chirp signal and the combined chirp signal using frequency-shift keying.

6. The method of claim 1 further comprises
receiving, by the receiver, the modulated signal; and
correlating, by the receiver, the modulated signal with a local chirp signal.

7. The method of claim 6 further comprises
down converting, by the receiver, the modulated signal to a lower frequency to form an intermediate frequency signal; and
bandpass filtering, by the receiver, the intermediate frequency signal prior to correlating the modulated signal with a local chirp signal.

8. The method of claim 6 wherein the local chirp signal is a chirp signal ramping at a rate that matches the ramp rate of the transmitted modulated signal.

9. The method of claim 6 further comprises extracting amplitude information from the correlated signal using an envelope detector.

10. A communication system having a transmitter and a receiver, the transmitter comprising:
a first signal generator outputting a first chirp signal ramping at a first rate;
a second signal generator outputting a second chirp signal ramping at a second rate which differs from the first rate;
a signal combiner configured to receive the first chirp signal and the second chirp signal and operates to combine the first chirp signal with the second chirp signal to form a combined chirp signal; and
a modulator configured to receive the combined chirp signal and modulate the combined chirp signal using on-off keying.

11. The system of claim 10 wherein the modulator is further defined as a power amplifier, such that combined chirp signal is modulated by enabling and disabling the power amplifier.

12. The system of claim 10 further comprises antenna associated with the transmitter and electrically coupled to the modulator.

13. The system of claim 10 wherein the first signal generator, the second signal generator, the signal combiner and the modulator are implemented by a digital signal processor.

14. The system of claim 10 where the receiver includes
a mixer configured to receive a signal from the transmitter and correlate the received signal with a local chirp signal, where the local chirp signal is a chirp signal ramping at a rate that matches the ramp rate of the transmitted modulated signal.

15. The system of claim 14 wherein the receiver further includes
a downconverter configured to receive the transmitted modulated signal and down convert the transmitted modulated signal to a lower frequency to form an intermediate frequency signal; and
a bandpass filter configured to receive the intermediate frequency signal from the downconverter.

16. A communication system having a transmitter and a receiver, the transmitter comprising:
a first signal generator outputting a first chirp signal ramping at a first rate;
a second signal generator outputting a second chirp signal ramping at a second rate which differs from the first rate;
a third signal generator outputting a third chirp signal ramping at a third rate which differs from the first rate and the second rate;
a chirp selector configured to receive the second chirp signal and the third chirp signal and operates to select one of the second chirp signal and the third chirp signal to output at a given time in accordance with an input signal; and
a signal combiner configured to receive the first chirp signal and output from the chirp selector and operates to combine the first chirp signal with the output from the chirp selector to form a combined chirp signal.

17. The system of claim 16 further comprises an amplifier configured to receive the combined chirp signal and an antenna electrically coupled to the amplifier.

18. The system of claim 16 wherein the first signal generator, the second signal generator, the third signal generator, the chirp selector and the signal combiner are implemented by a digital signal processor.

19. The system of claim 16 wherein the receiver includes
a mixer configured to receive a signal from the transmitter and correlate the received signal with a local chirp signal, where the local chirp signal is a chirp signal ramping at a rate that matches the ramp rate of the transmitted modulated signal.

20. The system of claim 19 wherein the receiver further includes
a downconverter configured to receive the received signal and down convert the received signal to a lower frequency to form an intermediate frequency signal; and
a bandpass filter configured to receive the intermediate frequency signal from the downconverter.
